(19) United States
(12) Patent Application Publication
(10) Pub. No.: US 2022/0402290 A1
(43) Pub. Date: Dec. 22, 2022

(54) PRECOATING AGENT, IMAGE FORMING METHOD, AND IMAGE FORMING APPARATUS

(71) Applicant: Konica Minolta, Inc., Tokyo (JP)

(72) Inventors: Daisuke KODAMA, Tokyo (JP); Naoko UEMURA, Tokyo (JP); Hidekazu KAWASAKI, Tokyo (JP)

(21) Appl. No.: 17/806,162

(22) Filed: Jun. 9, 2022

(30) Foreign Application Priority Data
Jun. 17, 2021 (JP) 2021-101021

(51) Int. Cl. B41M 7/00; C09D 151/08

(52) U.S. Cl. CPC B41M 7/0018; C09D 151/08

(57) ABSTRACT

The present invention provides a precoating agent which is used in an image forming method using an active ray curable ink and which is applied to a surface of a recording medium before the active ray curable ink is applied, the precoating agent comprising a crystalline resin and an active ray polymerizable compound.

### CROSS REFERENCE TO RELATED APPLICATIONS

The entire disclosure of Japanese Patent Application No.2021-101021 filed on Jun. 17, 2021, is incorporated herein by reference in its entirety.

### BACKGROUND

### Technological Field

The present invention relates to a precoating agent, an image forming method, and an image forming apparatus.

### Description of Related Art

The inkjet method, which enables digital printing without using plates, is used in a variety of printing fields because it can form images simply and inexpensively.

As inks used in the image forming method based on the inkjet method, active ray curable inks containing active ray polymerizable compounds are known. When irradiated with active rays, the active ray curable inks are cured by polymerization of the active ray polymerizable compounds to firmly attach colorants to recording media. By forming these cured films, the desired image can be formed.

On the other hand, when the active ray curable inks are applied to the surface of recording media that absorb inks such as paper in the above-described image forming method, a portion of the inks is absorbed by the recording media after landing and thus penetrates thereinto, making it difficult to control the ink droplet diameter to a predetermined size. Thus, irradiating the inks after the landing with active rays for curing sometimes fails to give images with good image quality due to reasons such as unevenness in image density.

As the method for suppressing ink penetration due to absorption of inks by the recording media, as described above, a method of applying a precoating agent to the surface of the recording media before the active ray curable inks are applied is known.

For example, Japanese Patent Application Laid-Open No. 2020-11381 discloses a method in which a lower printing layer is formed by printing a precoating agent that contains at least a gelling agent and contains no colorant, an upper printing layer is then formed by printing an inkjet ink containing a colorant on the lower printing layer, and the upper printing layer and the lower printing layer are cured at once by irradiating them with active rays under an atmosphere with an oxygen concentration of 10% or less. According to Japanese Patent Application Laid-Open No. 2020-11381, it is said that the above-described method enables the degree of cure expansion and shrinkage of the upper printing layer to be equal to that of the lower printing layer, thereby improving the close adhesion between the upper printing layer and the lower printing layer.

However, the present inventors have conducted investigations and found that, when the precoating agent described in Japanese Patent Application Laid-Open No. 2020-11381 is applied to a recording medium and cured, crystals of the gelling agent are oriented on the surface of the cured film of the precoating agent, resulting in decreased wettability of the ink applied to the surface of the precoating agent and ink repulsion. In particular, in high definition images formed with a small amount of ink droplets, the above-described ink repulsion causes tapering and chipping of fine lines, and therefore, degradation of image quality due to the ink repulsion is sometimes more easily visible than in images with a large amount of ink droplets.

### SUMMARY

The present invention has been made in view of the above-described circumstances, and an object thereof is to provide a precoating agent and an image forming method that can suppress ink repulsion and suppress tapering and chipping of fine lines in high definition images.

A precoating agent according to one embodiment of the present invention to solve the above-described problem is a precoating agent which is used in an image forming method using an active ray curable ink and which is applied to a surface of a recording medium before the active ray curable ink is applied, the precoating agent comprising a crystalline resin and an active ray polymerizable compound.

Also, an image forming method according to one embodiment of the present invention to solve the above-described problem comprises the following steps: applying the above-described precoating agent to a surface of a recording medium; irradiating, with first active rays, the surface to which the precoating agent has been applied; applying an active ray curable ink to the surface to which the precoating agent has been applied; and irradiating, with second active rays, the surface to which the active ray curable ink has been applied.

Also, an image forming apparatus according to one embodiment of the present invention to solve the above-described problem comprises: a precoating agent applicator that applies the above-described precoating agent to a surface of a recording medium; a first active ray irradiator that irradiates, with first active rays, the surface to which the precoating agent has been applied; an ink applicator that applies an active ray curable ink to the surface to which the precoating agent has been applied; and a second active ray irradiator that irradiates, with second active rays, the surface to which the active ray curable ink has been applied.

### BRIEF DESCRIPTION OF DRAWINGS

The advantageous and features provided by one embodiment of the invention will become more fully understood from the detailed description given hereinbelow and the appended drawings which are given by way of illustration only, and thus are not intended as a definition of the limits of the present invention:

FIG. 1 is a flowchart showing an image forming method according to one embodiment of the present invention; and

FIG. 2 is a schematic diagram showing the configuration of an image forming apparatus according to one embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, embodiments of the present invention will be described with reference to the accompanying drawings. Note that the present invention is not limited to the embodiments below.

1. Precoating Agent

A precoating agent according to one embodiment of the present invention is applied to a surface of a recording medium before an active ray curable ink (hereinafter, simply referred to as the “ink”), which will be mentioned later, is applied, and comprises a crystalline resin and an active ray curable compound.

1-1. Crystalline Resin

In the present invention, the “crystalline” resin is defined as a resin that has a distinct endothermic peak during temperature rise in the endothermic curve obtained by differential scanning calorimetry (DSC). Note that the term “distinct endothermic peak” as used herein means a peak whose half value width is 15° C. or less in differential scanning calorimetry (DSC) upon carrying out the measurement at a temperature rising rate of 10° C./min.

As mentioned above, precoating agents are applied to a surface of recording media that absorb inks such as paper before active ray curable inks are applied, in an attempt to control ink penetration into the absorbent recording media.

However, with conventional precoating agents, after applying the precoating agents to recording media, the precoating agents may be absorbed by the recording media before inks are applied, and the precoating agents cannot remain on the surface of the recording media, making it impossible to control ink penetration into the recording media.

As precoating agents that suppress absorption into the recording medium, precoating agents that contain a gelling agent are known, as described in Japanese Patent Application Laid-Open No. 2020-11381.

The present inventors have conducted investigations and found that, when the precoating agent containing the gelling agent described in Japanese Patent Application Laid-Open No. 2020-11381 is used, crystallization of the gelling agent increases the viscosity of the precoating agent and suppresses absorption of the precoating agent by the recording medium. As a result of this, the precoating agent does not penetrate into the recording medium, but remains on the recording medium, thereby suppressing ink penetration. However, after curing the precoating agent and the ink, the gelling agent oriented on the surface of the cured film of the precoating agent has a low surface energy, thus resulting in decreased wettability of the ink to the precoating agent. This sometimes causes the ink to spread less than expected on the surface of the precoating agent, resulting in occurrence of ink repulsion. The above-described ink repulsion sometimes decreases color development properties and uniformity of density in images formed by the ink.

In particular, in high definition images such as fine line images formed with a small amount of droplets, the above-described ink repulsion sometimes causes fine lines to become thin without spreading out or part of fine lines to be chipped off. Since the amount of ink droplets in high definition images such as fine line images is small, degradation of image quality due to the above-described tapering and chipping of fine lines is sometimes more easily visible than in normal images formed with a larger amount of ink droplets.

Then, the present inventors have thought that, by allowing the precoating agent to contain a material that has a function of a gelling agent, which thickens the precoating agent by crystallization and makes it difficult to be absorbed by the recording medium, and that can also suppress a decrease in the wettability of the ink to the precoating agent, ink repulsion can be suppressed while controlling ink penetration.

According to investigations by the present inventors, it has been found that crystalline resins can be crystallized in the precoating agent, which can thus increase the viscosity of the precoating agent. As a result of this, it has been found that the precoating agent can be made less likely to be absorbed by the recording medium, making it easier for the precoating agent to remain on the recording medium and controlling ink penetration.

Furthermore, diligent investigations by the present inventors have revealed that, by allowing the precoating agent to contain a crystalline resin, it is possible to suppress ink repulsion, resulting in suppression of occurrence of tapering and chipping in fine line images. Although the reason for this is not clear, it is thought to be because, when the precoating agent contains a crystalline resin, the surface energy thereof can be increased, and also because the affinity between the crystalline resin and the active ray polymerizable compound contained in the ink can be enhanced by the interaction between them. Based on the above-described thought, the present inventors have conducted investigations, and found that a decrease in the wettability of the ink to the precoating agent can be suppressed and ink repulsion can be suppressed compared to conventional precoating agents not containing a gelling agent.

In addition, conventional precoating agents cause excessive precoating to permeate the recording medium, resulting in relatively weak interaction with the ink and decreased close adhesion to the ink layer, and therefore, when the recording medium is folded, the image formed by the ink cannot follow the precoating agent, causing the image to be peeled off and cracked.

Furthermore, as mentioned above, the wettability of the ink to the precoating agent containing a gelling agent is low, which may decrease the close adhesion between the surface of the precoating agent and the ink. If the above-described close adhesion is decreased, when the recording medium is folded, the image formed by the ink cannot follow the precoating agent, causing the image to be peeled off and cracked.

According to the investigations by the present inventors, it has been found that, since the precoating agent according to the present invention contains a crystalline resin, ink penetration can be suppressed and a decrease in the wettability of the ink to the precoating agent can also be suppressed, thereby enhancing the close adhesion between the surface of the precoating agent and the ink. As a result of this, it has been found that peeling and cracking of the image when folding the recording medium can be suppressed.

The melting point (Tm) of the crystalline resin is preferably 40° C. or higher and 100° C. or lower, and more preferably 50° C. or higher and 80° C. or lower. If the melting point is 40° C. or higher, when applying the precoating agent to the recording medium, part of the crystalline resin is melted and absorption of the precoating agent by the recording medium can be better suppressed. In addition, in the storage state of recording media having the precoating agent applied thereto and recording media having the precoating agent and the ink applied thereto, the occurrence of blocking, in which the recording media are attached to each other, can be better suppressed. Also, since the precoating agent is applied after heating the precoating agent to melt the crystalline resin, when the melting point is 100° C. or lower, the precoating agent can be applied to the recording medium at a lower temperature.

The melting point (Tm) of the crystalline resin can be determined by, for example, using a differential scanning calorimeter “Diamond DSC” (manufactured by PerkinElmer, Inc.). The measurement is carried out according to the measurement conditions (temperature rising and cooling conditions) in which a first temperature rise process where the temperature is raised from room temperature (25° C.) to 150° C. at a rising and descending rate of 10° C./min and held isothermally at 150° C. for 5 minutes, a cooling process where the temperature is cooled from 150° C. to 0° C. at a cooling rate of 10° C./min and held isothermally at 0° C. for 5 minutes, and a second temperature rise process where the temperature is raised from 0° C. to 150° C. at a rising and descending rate of 10° C./min are performed in the order presented. The above-described measurement is carried out by sealing 3.0 mg of the crystalline resin sample in an aluminum pan and setting it in the sample holder of a differential scanning calorimeter “Diamond DSC”. An empty aluminum pan is used as the reference. In the above-described measurement, analysis is carried out from the endothermic curve obtained by the first temperature rise process, and the top temperature of the endothermic peak derived from the crystalline resin is taken as the melting point (Tm) of the crystalline resin.

The recrystallization temperature (Rc) of the crystalline resin can be determined by, for example, using a differential scanning calorimeter “Diamond DSC” (manufactured by PerkinElmer, Inc.). The measurement is carried out according to the measurement conditions in which a temperature rise process where the temperature is raised from room temperature (25° C.) to 100° C. at a rising and descending rate of 10° C./min and held isothermally at 100° C. for 1 minute and a cooling process where the temperature is cooled from 100° C. to 0° C. at a cooling rate of 0.1° C./min are performed in the order presented. The above-described measurement is carried out by sealing 3.0 mg of the crystalline resin sample in an aluminum pan and setting it in the sample holder of a differential scanning calorimeter “Diamond DSC”. An empty aluminum pan is used as the reference. In the above-described measurement, analysis is carried out from the exothermic curve obtained by the cooling process, and the top temperature of the exothermic peak derived from the crystalline resin is taken as the recrystallization temperature (Rc) of the crystalline resin.

The content of the crystalline resin in the precoating agent is not particularly limited, but it is preferably 1 mass % or more and 12 mass % or less, more preferably 1 mass % or more and 10 mass % or less, more preferably 3 mass % or more and 10 mass % or less, and still more preferably 3 mass % or more and 9 mass % or less, relative to the entire mass of the precoating agent. When the content of the crystalline resin is 1 mass % or more, crystallization of the crystalline resin in the precoating agent applied to the recording medium increases the viscosity of the precoating agent, making it more difficult for the precoating agent to be absorbed by the recording medium. As a result of this, the precoating agent can easily remain on the surface of the recording medium, thereby suppressing penetration of the ink applied to the surface of the precoating agent. Also, when the content of the crystalline resin is 3 mass % or more, the viscosity of the precoating agent can be further increased and absorption into the recording medium can be better suppressed. Therefore, when the ink is applied to the surface of the precoating agent to form an image (for example, a solid image), the color development properties and uniformity of density in the image can be further enhanced.

In addition, when the above-described content of the crystalline resin is 12 mass % or less, the flowability of the precoating agent can be enhanced without excessively increasing the viscosity of the precoating agent, and the precoating agent can be more easily and uniformly applied on the recording medium. When the above-described content of the crystalline resin is 10 mass % or less, the flowability of the precoating agent can be further enhanced. Due to these reasons, if the content of the crystalline resin is in the above-described range, when the ink is applied to the surface of the precoating agent to form an image (for example, a solid image), it is possible to suppress ink repulsion while suppressing ink penetration in the image, thereby further enhancing the color development properties and uniformity of density in the image. Also, the precoating agent can be applied more uniformly onto the recording medium, and therefore, ink repulsion can be better suppressed, and tapering of fine lines can be suppressed more sufficiently.

In addition, when the content of the crystalline resin is 10 mass % or less, a decrease in the mechanical strength of the precoating agent clue to excessive crystallization can be better suppressed, and therefore, cracking of the cured precoating agent due to folding of the recording medium can be better suppressed and peeling of the image due to cracking of the cured precoating agent can be better suppressed.

In the present embodiment, the crystalline resin contained in the precoating agent is not particularly limited as long as it is as defined above, and any known crystalline resin can be used. Examples of the above-described crystalline resin include crystalline polyester resins, crystalline polyurethane resins, crystalline polyurea resins, crystalline polyamide resins, and crystalline polyether resins. One type of crystalline resin may be used alone, or two or more types of crystalline resins may be used in combination. Among these, from the viewpoint of better suppressing ink repulsion, it is preferable that the above-described crystalline resin include a crystalline polyester resin.

Among crystalline resins, crystalline polyester resins have higher affinity with the active ray polymerizable compound contained in the ink. Therefore, they can enhance the close adhesion between the ink applied to the surface of the precoating agent and the precoating agent, thereby suppressing a decrease in the wettability of the ink and better suppressing ink repulsion.

The crystalline polyester resin can be obtained by a polycondensation reaction between a dihydric or higher alcohol (polyhydric alcohol component) and a di- or higher carboxylic acid (polycarboxylic acid component).

Polyhydric alcohol compounds are compounds having two or more hydroxy groups in one molecule. Examples of the polyhydric alcohol component include dihydric alcohols such as ethylene glycol, propylene glycol, butanediol, diethylene glycol, hexanediol (1,2-hexanediol, 1,6-hexanediol), cyclohexanediol, octanediol, decanediol, dodecanediol, ethylene oxide adduct of bisphenol A, and propylene oxide adduct of bisphenol A; trihydric or higher polyols such as glycerin, pentaerythritol, hexamethylolmelamine, hexaethylolmelamine, tetramethylolbenzoguanamine, and tetraethylolbenzoguanamine; and their ester compounds and hydroxycarboxylic acid derivatives.

From the viewpoint of enhancing the crystallinity of the crystalline polyester resin, the above-described polyhydric alcohol compound is preferably a dihydric aliphatic alcohol, and more preferably a dihydric linear aliphatic alcohol. Note that only one type of the above-described polyhydric alcohol compounds may be used alone, or two or more types thereof may be used in combination.

Polycarboxylic acid compounds are compounds having two or more carboxy groups in one molecule, and alkyl esters, acid anhydrides, and acid chlorides of polycarboxylic acid compounds can be used. Examples of the polycarboxylic acid component include dicarboxylic acids such as oxalic acid, succinic acid, maleic acid, mesaconic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-dicarboxylic acid, malic acid, citric acid, hexahydroterephthalic acid, malonic acid, pimelic acid, tartaric acid, mucic acid, phthalic acid, isophthalic acid, terephthalic acid, tetrachlorophthalic acid, chlorophthalic acid, nitrophthalic acid, p-carboxyphenylacetic acid, p-phenylenediacetic acid, m-phenylenediglycolic acid, p-phenylenediglycolic acid, o-phenylenediglycolic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid, and dodecenylsuccinic acid; tri- or higher carboxylic acids such as trimellitic acid, pyromellitic acid, naphthalenetricarboxylic acid. naphthalenetetracarboxylic acid, pyrenetricarboxylic acid, and pyrenetetracarboxylic acid; and their alkyl esters, acid anhydrides, and acid chlorides.

From the viewpoint of enhancing the crystallinity of the crystalline polyester resin, the above-described polycarboxylic acid compound is preferably an aliphatic dicarboxylic acid. Note that only one type of the above-described polycarboxylic compounds may be used alone, or two or more types thereof may be used in combination.

The ratio of the above-described polyhydric alcohol compound to the above-described polycarboxylic acid compound in the monomers for synthesizing the crystalline polyester resin is, in terms of the hydroxy group [OH] equivalent of the polyhydric alcohol compound to the carboxy group [COOH] equivalent of the polycarboxylic acid compound, preferably ½ or more and 2 or less, and more preferably ⅔ or more and 3/2 or less. With the ratio of the hydroxy group [OH] equivalent of the polyhydric alcohol compound to the carboxy group [COOH] equivalent of the polycarboxylic acid compound in the above-described range, the molecular weight of the crystalline polyester resin can be adjusted to the desired range.

Also, specific examples of the combination of a polycarboxylic acid compound and a polyhydric alcohol compound for forming the crystalline polyester resin include 1,12-dodecanediol (having 12 carbon atoms) and succinic acid (having 4 carbon atoms), 1,12-dodecanediol (having 12 carbon atoms) and sebacic acid (having 10 carbon atoms), ethylene glycol (having 2 carbon atoms) and sebacic acid (having 10 carbon atoms), 1,6-hexanediol (having 6 carbon atoms) and sebacic acid (having 10 carbon atoms), 1,6-hexanediol (having 6 carbon atoms) and decanedicarboxylic acid (having 12 carbon atoms), 1,9-nonanediol (having 9 carbon atoms) and decanedicarboxylic acid (having 12 carbon atoms), and ethylene glycol (having 2 carbon atoms) and dodecanedicarboxylic acid (having 14 carbon atoms).

The weight average molecular weight (Mw) of the crystalline polyester resin can normally be 5,000 or more and 50,000 or less, but it is preferably 7,000 or more and 30,000 or less, and more preferably 10,000 or more and 25,000 or less. When the weight average molecular weight is 5,000 or more, the viscosity of the precoating agent can be further increased to make it easier for the precoating agent to remain on the surface of the recording medium without being absorbed by the recording medium, and when the weight average molecular weight is 50,000 or less, the melting point of the crystalline resin can be lowered to make it easier to apply the precoating agent to the recording medium.

The measurement of the weight average molecular weight (Mw) of the crystalline polyester resin is carried out by using a GPC apparatus (HLC-8120GPC, manufactured by Tosoh Corporation) and columns (TSK guardcolumn+TSKgel SuperHZ-M (three in series), manufactured by Tosoh Corporation), and feeding tetrahydrofuran as the carrier solvent at a flow rate of 0.2 mL/min while holding the column temperature at 40° C. Along with the above-described carrier solvent, 10 μL of the prepared sample solution is injected into the GPC apparatus, the sample is detected using a refractive index detector (RI detector), and the molecular weight distribution of the sample can be calculated using a calibration curve measured using monodisperse polystyrene standard particles.

From the viewpoint of more sufficiently suppressing ink repulsion, it is preferable that the crystalline polyester resin include a styrene-acrylic modified polyester resin. When the crystalline polyester resin includes a styrene-acrylic modified polyester resin, the affinity with the active ray polymerizable compound in the ink can be further enhanced. Although the reason for this is not clear, it is thought to be because the active ray polymerizable compound contained in the ink can be captured inside the steric structure formed by the aromatic ring that the styrene monomer constituting the styrene-acrylic modified polyester resin has, thereby sufficiently enhancing the close adhesion between the precoating agent and the ink. Therefore, when the precoating agent contains a styrene-acrylic modified polyester resin, ink repulsion can be better suppressed, and tapering and chipping of fine line images can be suppressed.

Styrene-acrylic modified polyester resins refer to resins in which a crystalline polyester segment constituted by a polyester resin and a styrene-acrylic segment constituted by a styrene-acrylic copolymer are bonded via a bireactive compound. The crystalline polyester segment refers to a set of structural units derived from the crystalline polyester resin in the styrene-acrylic modified polyester resin. The styrene-acrylic segment refers to a set of structural units derived from styrene acryl in the styrene-acrylic modified polyester resin.

The above-described styrene-acrylic modified polyester resin can be obtained by carrying out a polymerization reaction to produce the styrene-acrylic resin in the presence of the crystalline polyester resin that has been prepared in advance, or by carrying out a polymerization reaction to produce the crystalline polyester resin in the presence of the styrene-acrylic resin that has been prepared in advance.

The above-described bireactive compound is a compound that has a substituent that can react with both the crystalline polyester segment and the styrene-acrylic segment, as well as a polymerizable unsaturated group. Examples of the bireactive compound include (meth)acrylic acid, fumaric acid, maleic acid, and maleic anhydride.

The styrene monomer, which is a component constituting the styrene-acrylic copolymer, is a monomer that contains a styrene structure and has an ethylenically unsaturated bond that can undergo radical polymerization. Examples of the styrene monomer include styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrene, 3,4-dichlorostyrene, and derivatives thereof. Only one type of these styrene monomers may be used alone, or two or more types thereof may be used in combination. Note that, when a (meth)acrylic acid monomer such as acrylic acid and methacrylic acid, which can also act as a bireactive compound, is used, it is not necessary to use a bireactive compound different from the above-described (meth)acrylic acid monomer when synthesizing the styrene-acrylic modified polyester resin.

The (meth)acrylic acid monomer, which is a component constituting the above-described styrene-acrylic copolymer, is a monomer that contains a (meth)acrylic group and has an ethylenically unsaturated bond that can undergo radical polymerization. Examples of the above-described acrylic acid monomer include acrylic acid, methacrylic acid, methyl acrylate, ethyl acrylate, butyl acrylate, 2-ethylhexyl acrylate, cyclohexyl acrylate, phenyl acrylate, ethyl β-hydroxyacrylate, propyl γ-aminoacrylate; diacrylates of dihydric alcohols such as ethylene glycol, propylene glycol, butylene glycol, and hexylene glycol; and dimethacrylates or trimethacrylates of trihydric or higher alcohols such as pentaerythritol and trimethylolpropane. Also, examples of the methacrylic acid compound include methyl methacrylate, ethyl methacrylate, butyl methacrylate, hexyl methacrylate, 2-ethylhexyl methacrylate, stearyl methacrylate, dimethylaminoethyl methacrylate, and diethylaminoethyl methacrylate. Only one type of these (meth)acrylic acid monomers may be used alone, or two or more types thereof may be used in combination.

Other polymerizable compounds can also be used in synthesis of the styrene-acrylic copolymer. Examples of the other polymerizable compound that can be used include monofunctional vinyl monomers and polyfunctional vinyl monomers. Examples of the above-described monofunctional vinyl monomer include acid monomers such as maleic anhydride and vinyl acetic acid, acrylamide, methacrylamide, acrylonitrile, ethylene, propylene, butylene, vinyl chloride, and N-vinylpyrrolidone.

Examples of the above-described polyfunctional vinyl monomer include butadiene and divinylbenzene.

The above-described styrene-acrylic copolymer can be obtained by adding to the polymerization of the above-described monomers an arbitrary polymerization initiator such as a peroxide, a persulfide, or an azo compound, which is normally used, and performing polymerization by known polymerization techniques such as bulk polymerization, solution polymerization, emulsion polymerization, miniemulsion method, suspension polymerization, and dispersion polymerization. During the polymerization, a normally used chain transfer agent such as an alkyl mercaptan or a mercapto fatty acid ester can be used for the purpose of adjusting the molecular weight.

The styrene-acrylic modification rate, which indicates the proportion of the styrene-acrylic polymerization segment in the crystalline polyester resin, is preferably 40 mass % or less relative to the entire mass of the crystalline polyester resin. When the styrene-acrylic modification rate is 40 mass % or less, a decrease in crystallinity due to the styrene-acrylic modification is better suppressed, making it easier for the crystalline polyester resin to be crystallized. This suppresses absorption of the precoating agent by the recording medium, making it easier for the precoating agent to remain on the surface of the recording medium and suppressing ink penetration. From the above-described viewpoint, the styrene-acrylic modification rate is preferably 0.1 mass % or more and 40 mass % or less, more preferably 0.1 mass % or more and 35 mass % or less, and still more preferably 0.2 mass % or more and 30 mass % or less. When the styrene-acrylic modification rate is 0.1 mass % or more, the affinity between the precoating agent and the ink can be enhanced and ink repulsion can be better suppressed.

The above-described styrene-acrylic modification rate can be specifically determined from the mass proportions of the aromatic vinyl monomer and the (meth)acrylic acid ester monomer relative to the entire mass of the resin materials used for synthesizing the styrene-acrylic modified polyester resin, that is, the entire mass of the monomer constituting the unmodified polyester resin, which will be the polyester segment, and the aromatic vinyl monomer and the (meth)acrylic acid ester monomer, which will be the styrene-acrylic polymer segment, and the bireactive compound for bonding them in total.

1-2. Active Ray Polymerizable Compound

Active ray polymerizable compounds are compounds that are polymerized and crosslinked to be cured by irradiation with active rays. Accordingly, in the present embodiment, the precoating agent, which contains an active ray polymerizable compound, is cured by irradiation with active rays.

Examples of the above-described active ray polymerizable compound include radical polymerizable compounds, cationic polymerizable compounds, or mixtures thereof. Among these, the above-described active ray polymerizable compound is preferably a radical polymerizable compound. Note that the above-described active ray polymerizable compound may be either monofunctional or polyfunctional, and may be a monomer, a polymerizable oligomer, a prepolymer, or a mixture thereof.

Examples of the above-described active rays include electron beams, ultraviolet rays, α rays, γ rays, and x rays. Among these, ultraviolet rays and electron beams are preferred as the above-described active rays, and ultraviolet rays are more preferred.

Radical polymerizable compounds are monofunctional or polyfunctional compounds that have an ethylenically unsaturated bond that is capable of undergoing radical polymerization in the molecule. Examples of the compound that has an ethylenically unsaturated bond that is capable of undergoing radical polymerization include unsaturated carboxylic acids and salts thereof, unsaturated carboxylic acid ester compounds, unsaturated carboxylic acid urethane compounds, unsaturated carboxylic acid amide compounds and anhydrides thereof, acrylonitrile, styrene, unsaturated polyesters, unsaturated polyethers, unsaturated polyamides, and unsaturated urethanes. Examples of the unsaturated carboxylic acid include (meth)acrylic acid, itaconic acid, crotonic acid, isocrotonic acid, and maleic acid.

The radical polymerizable compound is preferably an unsaturated carboxylic acid ester compound, and is more preferably a (meth)acrylate. Note that the term “(meth)acrylate” as used herein means acrylate or methacrylate, and the term “(meth)acrylic” means acrylic or methacrylic.

Examples of the monofunctional (meth)acrylate include isoamyl (meth)acrylate, stearyl (meth)acrylate, isobornyl (meth)acrylate, lauryl (meth)acrylate, octyl (meth)acrylate, decyl (meth)acrylate, isomyristyl (meth)acrylate, isostearyl (meth)acrylate, 2-phenoxyethyl (meth)acrylate, 2-ethylhexyl-diglycol (meth)acrylate, 2-hydroxybutyl (meth)acrylate, 2-(meth)acryloyloxyethyl hexahydrophthalate, butoxyethyl (meth)acrylate, ethoxy diethylene glycol (meth)acrylate, methoxy diethylene glycol (meth)acrylate, methoxy polyethylene glycol (meth)acrylate, methoxy propylene glycol (meth)acrylate, phenoxyethyl (meth)acrylate, tetrahydrofurfuryl (meth)acrylate, isobornyl (meth)acrylate, 2-hydroxyethyl (meth)acrylate, 2-hydroxypropyl (meth)acrylate, 2-hydroxy-3-phenoxypropyl (meth)acrylate, 2-(meth)acryloyloxyethyl succinate, 2-(meth)acryloyloxyethyl phthalate, 2-(meth)acryloyloxyethyl-2-hydroxyethyl phthalate, and t-butylcyclohexyl (meth)acrylate. Only one type of the above-described monofunctional (meth)acrylates may be used alone, or two or more types thereof may be used in combination.

Examples of the polyfunctional (meth)acrylate include difunctional (meth)acrylates including triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, di(meth)acrylate of bisphenol A PO adduct, neopentyl glycol di(meth)acrylate hydroxypivalate, polytetramethylene glycol di(meth)acrylate, polyethylene glycol diacrylate, and tripropylene glycol diacrylate; trifunctional or higher (meth)acrylates including trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, glycerol propoxy tri(meth)acrylate, and pentaerythritol ethoxy tetra(meth)acrylate; oligomers having (meth)acryloyl groups including polyester acrylate oligomers; and modified products thereof.

Examples of the above-described modified product include ethylene oxide modified (EO modified) (meth)acrylates into which ethylene oxide groups have been inserted and propylene oxide modified (PO modified) (meth)acrylates into which propylene oxide has been inserted. Only one type of the above-described polyfunctional (meth)acrylates may be used alone, or two or more types thereof may be used in combination.

Cationic polymerizable compounds are monofunctional or polyfunctional compounds that have a cationic polymerizable group in the molecule. Examples of the cationic polymerizable compound include epoxy compounds, vinyl ether compounds, and oxetane compounds.

Examples of the monofunctional epoxy compound include vinyl cyclohexene monoepoxide.

Examples of the polyfunctional epoxy compound include alicyclic epoxy resins such as 3,4-epoxycyclohexylmethyl 3′,4′-epoxycyclohexanecarboxylate, bis(3,4-epoxycyclohexylmethyl) adipate, ε-caprolactone modified 3,4-epoxycyclohexylmethyl 3′,4′-epoxycyclohexanecarboxylate, 1-methyl-4-(2-methyloxiranyl)-7-oxabicyclo[4,1,0] heptane, 2-(3,4-epoxycyclohexyl-5,5-spiro-3,4-epoxy)cyclohexanone-meta-dioxane, and bis(2,3-epoxycyclopentyl) ether; aliphatic epoxy compounds including diglycidyl ether of 1,4-butanediol, diglycidyl ether of 1,6-hexanediol, triglycidyl ether of glycerin, triglycidyl ether of trimethylolpropane, diglycidyl ether of polyethylene glycol, diglycidyl ether of propylene glycol, and polyglycidyl ethers of polyether polyols obtained by adding one type of or two or more types of alkylene oxide (such as ethylene oxide and propylene oxide) to aliphatic polyhydric alcohols such as ethylene glycol, propylene glycol, and glycerin; and di- or polyglycidyl ether of bisphenol A or alkylene oxide adducts thereof, di- or polyglycidyl ether of hydrogenated bisphenol A or alkylene oxide adducts thereof, and aromatic epoxy compounds including novolac epoxy resins.

Examples of the monofunctional vinyl ether compound include ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, and cyclohexanedimethanol monovinyl ether, n-propyl vinyl ether, isopropyl vinyl ether, isopropenyl ether-o-propylene carbonate, dodecyl vinyl ether, diethylene glycol monovinyl ether, and octadecyl vinyl ether.

Examples of the polyfunctional vinyl ether compound include di- or trivinyl ether compounds including ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexanedimethanol divinyl ether, and trimethylolpropane trivinyl ether.

Examples of the monofunctional oxetane compound include 3-hydroxymethyl-3-methyloxetane, 3-hydroxymethyl-3-ethyloxetane, 3-hydroxymethyl-3-propyloxetane, 3-hydroxymethyl-3-n-butyloxetane, 3-hydroxymethyl-3-phenyloxetane, 3-hydroxymethyl-3-benzyloxetane, 3-hydroxyethyl-3-methyloxetane, 3-hydroxyethyl-3-ethyloxetane, 3-hydroxyethyl-3-propyloxetane, 3-hydroxyethyl-3-phenyloxetane, 3-hydroxypropyl-3-methyloxetane, 3-hydroxypropyl-3-ethyloxetane, 3-hydroxypropyl-3-propyloxetane, 3-hydroxypropyl-3-phenyloxetane, 3-hydroxybutyl-3-methyl oxetane, and 3-ethyl-3-(2-ethylhexyloxylmethyl)oxetane.

Examples of the polyfunctional oxetane compound include 1,4-bis{[(3-ethyl-3-oxetanyl)methoxy]methyl}benzene and di[1-ethyl(3-oxetanyl)]methyl ether.

From the viewpoint of enhancing the close adhesion to the base material and the ink and better suppressing ink repulsion, it is preferable that the radical polymerizable compound have an aromatic structure or alicyclic structure, ethylene oxide modification by which ethylene oxide groups are inserted (EO modification), or propylene oxide modification by which propylene oxide is inserted (PO modification). From the viewpoint of improving the flexibility of the coating film of the precoating agent applied to the recording medium, it is preferable that the radical polymerizable compound has ethylene oxide modification by which ethylene oxide groups are inserted (EO modification) or propylene oxide modification by which propylene oxide is inserted (PO modification).

The content of the active ray polymerizable compound relative to the entire mass of the precoating agent is not particularly limited, but it is preferably 70 mass % or more and 99 mass % or less, and more preferably 80 mass % or more and 95 mass % or less. When the content is 70 mass % or more, the precoating agent can be more sufficiently cured, and when the content is 99 mass % or less, the crystalline resin, polymerization initiator, polymerization inhibitor, and the like, which will be mentioned later, can be more sufficiently contained in the precoating agent.

It is preferable that the active ray polymerizable compound include a monofunctional compound with a content of 50 mass % or more relative to the entire mass of the precoating agent, and the content is preferably 50 mass % or more and 95 mass % or less, and more preferably 60 mass % or more and 90 mass % or less. Monofunctional compounds do not form crosslinked structures as compared to polyfunctional compounds. Therefore, if the content of the monofunctional compound is 50 mass % or more, when the precoating agent is applied to the surface of the recording medium and cured, the plasticity of the precoating agent can be enhanced and the followability to folding of the recording medium can be enhanced. As a result of this, the ink image, which closely adheres to the surface of the precoating agent, can easily follow along with the precoating agent, and peeling of the ink image from the precoating agent and cracking thereof can be better suppressed. Also, when the content is 95 mass % or less, the elastic modulus of the precoating agent after curing can be increased and the blocking properties of the output image can be suppressed.

1-3. Other Components

(Polymerization Initiator)

In the present embodiment, the precoating agent may contain a polymerization initiator. The polymerization initiator may be any polymerization initiator as long as it is capable of initiating polymerization of the above-mentioned active ray polymerizable compound by irradiation with active rays. For example, when the precoating agent has a radical polymerizable compound, the polymerization initiator can be a photo-radical initiator, and when the above-described active ray curable ink has a cationic polymerizable compound, the polymerization initiator can be a photo-cationic initiator (photo-acid generator). Note that, when the precoating agent can be sufficiently cured without the polymerization initiator, such as when the precoating agent is cured by irradiation with electron beams, there is no need for the polymerization initiator.

The radical polymerization initiator includes intramolecular bond cleavage type radical polymerization initiators and intramolecular hydrogen abstraction type radical polymerization initiators.

Examples of the intramolecular bond cleavage type radical polymerization initiator include initiators including diethoxyacetophenone, 2-hydroxy-2-methyl-1-phenylpropan-1-one, benzyl dimethyl ketal, 1-(4-isopropylphenyl)-2-hydroxy-2-methylpropan-1-one, 4-(2-hydroxyethoxy)phenyl-(2-hydroxy-2-propyl) ketone, 1-hydroxycyclohexyl-phenyl ketone, 2-methyl-2-morpholino(4-methylthiophenyl)propan-1-one, and 2-benzyl-2-dimethylamino-1-(4-morpholino phenyl)-butanone, benzoins including benzoin, benzoin methyl ether, and benzoin isopropyl ether, acylphosphine oxide initiators including 2,4,6-trimethylbenzoindiphenylphosphine oxide, and benzyl and methylphenyl glyoxyesters.

Examples of the intramolecular hydrogen abstraction type radical polymerization initiator include benzophenone initiators including benzophenone, methyl o-benzoylbenzoate, 4-phenylbenzophenone, 4,4′-dichlorobenzophenone, hydroxybenzophenone, 4-benzoyl 4′-methyl-diphenyl sulfide, acrylated benzophenone, 3,3′,4,4′-tetra(t-butylperoxycarbonyl)benzophenone, and 3,3′-dimethyl-4-methoxybenzophenone; thioxanthone initiators including 2-isopropylthioxanthone, 2,4-dimethylthioxanthone, 2,4-diethylthioxanthone, and 2,4-dichlorothioxanthone; aminobenzophenone initiators including Michler's ketone and 4,4′-diethylaminobenzophenone; and 10-butyl-2-chloroacridone, 2-ethylanthraquinone, 9,10-phenanthrenequinone, and camphorquinone.

Examples of the cationic polymerization initiator include photo-acid generators. Examples of the photo-acid generator include B(C₆F₅)₄⁻, PF₆⁻, AsF₆⁻, SbF₆⁻, CF₃SO₃⁻ salts of aromatic onium compounds including diazonium, ammonium, iodonium, sulfonium, and phosphonium; sulfonates that generate sulfonic acid; halides that photo-generate hydrogen halides; and iron-arene complexes.

The content of the polymerization initiator is not particularly limited as long as it is in the range where the precoating agent is sufficiently cured by irradiation with active rays (for example, ultraviolet rays) and the coatability to the surface of the recording medium is not decreased. For example, the content of the polymerization initiator is preferably 0.1 mass % or more and 20 mass % or less, and more preferably 1 mass % or more and 10 mass % or less, relative to the entire mass of the precoating agent.

(Polymerization Inhibitor)

In the present embodiment, the precoating agent may contain a polymerization inhibitor.

Examples of the polymerization inhibitor include (alkyl)phenols, hydroquinone, catechol, resorcin, p-methoxyphenol, t-butylcatechol, t-butylhydroquinone, pyrogallol, 1,1-picrylhydrazyl, phenothiazine, p-benzoquinone, nitrosobenzene, 2,5-di-t-butyl-p-benzoquinone, dithiobenzoyl disulfide, picric acid, cupferron, aluminum N-nitrosophenylhydroxylamine, tri(p-nitrophenyl)methyl, N-(3-oxyanilino-1,3-dimethylbutylidene)aniline oxide, dibutyl cresol, cyclohexanone oxime cresol, guaiacol, o-isopropylphenol, butylaldoxime, methyl ethyl ketoxime, and cyclohexanone oxime.

The content of the above-described polymerization inhibitor is not particularly limited, but it is preferably 0.1 mass % or more and 10 mass % or less relative to the entire mass of the precoating agent.

(Surfactant)

In the present embodiment, the precoating agent may contain a surfactant for adjusting the surface tension.

Examples of the surfactant include anionic surfactants including dialkyl sulfosuccinates, alkylnaphthalene sulfonates, and fatty acid salts; nonionic surfactants including polyoxyethylene alkyl ethers, polyoxyethylene alkylallyl ethers, acetylene glycols, and polyoxyethylene-polyoxypropylene block copolymers; cationic surfactants including alkylamine salts and quaternary ammonium salts; silicone surfactants; and fluorinated surfactants.

The content of the surfactant is not particularly limited, but it is preferably 0.001 mass % or more and 10 mass % or less, and more preferably 0.001 mass % or more and 1.0 mass % or less, relative to the entire mass of the ink.

(Gelling Agent)

In the present embodiment, the precoating agent may contain a gelling agent. As the above-described gelling agent, those that are the same as the gelling agents contained in the active ray curable ink, which will be mentioned later, can be used.

The content of the gelling agent is not particularly limited, but it is preferably less than 1 mass %, more preferably less than 0.5 mass %, and still more preferably less than 0.1 mass %, relative to the entire mass of the precoating agent. When the content is less than 1 mass %, a decrease in the wettability of the ink to the precoating agent can be more sufficiently suppressed and ink repulsion can be more sufficiently suppressed.

1-4. Physical Properties of Precoating Agent

The viscosity of the precoating agent at 80° C. is preferably 3 mPa·s or more and less than 20 mPa·s, and more preferably 5 mPa·s or more and less than 15 mPa·s. When the above-described viscosity is in the above-described range, stable injectability in the inkjet system can be obtained. Also, the viscosity at 25° C. is preferably 1,000 mPa·s or more. When it is 1,000 mPa·s or more, the precoating agent is less likely to be absorbed by the recording medium at the time of landing, and the precoating agent is more likely to remain on the surface of the recording medium.

The above-described viscosities can be measured by a rheometer. For example, the above-described precoating agent is heated to 100° C., and while measuring the viscosity by a stress-controlled rheometer (manufactured by Anton Paar GmbH, Physica MCR301 (cone plate diameter: 75 mm, cone angle: 1.0°)), the ink is cooled down to 20° C. under conditions of a shear rate of 11.7 (1/s) and a temperature descending rate of 0.1° C./s, thereby obtaining a temperature change curve of viscosity. The above-described viscosities can be obtained by reading the viscosity at 40° C. from the obtained temperature change curve.

2. Active Ray Curable Ink

The active ray curable ink applied to the surface of the precoating agent in the present embodiment is an ink that contains an active ray polymerizable compound and is cured by polymerization and crosslinking of the active ray polymerizable compound upon irradiation with active rays.

2-1. Active Ray Polymerizable Compound

In the present embodiment, the active ray polymerizable compound contained in the active ray curable ink may include the active ray polymerizable compound contained in the above-mentioned precoating agent.

Also, the content of the above-described active ray polymerizable compound is preferably 1 mass % or more and 97 mass % or less, more preferably 30 mass % or more and 90 mass % or less, still more preferably 50 mass % or more and 90 mass % or less, and particularly preferably 80 mass % or more and 90 mass % or less, relative to the entire mass of the active ray curable ink.

2-2. Gelling Agent

In the present embodiment, it is preferable that the active ray curable ink contain a gelling agent. The gelling agent is an organic material that is solid at ordinary temperature but becomes liquid when heated, thereby enabling the above-described active ray curable ink to undergo a sol-gel phase transition in response to temperature changes.

It is also preferable that the above-described gelling agent be crystallized in the ink at a temperature at or below the gelation temperature of the ink. The gelation temperature as used herein refers to the temperature at which the ink undergoes a phase transition from sol to gel and the viscosity of the ink is suddenly changed when the ink that has been made into sol or liquid by heating is cooled down. Specifically, the ink that has been made into sol or liquid is cooled while measuring its viscosity with, for example, a rheometer MCR300 (manufactured by Anton Paar GmbH), and the temperature at which the viscosity suddenly rises can be taken as the gelation temperature of that ink.

When the above-described gelling agent is crystallized in the ink, a structure may be formed where the active ray polymerizable compound is encapsulated in the three-dimensional space formed by the above-described gelling agent and wax crystallized in the form of plates (such a structure is hereinafter referred to as a “card house structure”). When the card house structure is formed, the active ray polymerizable compound in a liquid state is held within the above-described space, making it more difficult for dots formed by ink attachment to penetrate, thereby further enhancing the pinning properties of the ink. The enhanced pinning properties of the ink can suppress excessive wetting and spreading of the droplets formed when the ink is applied to the surface of the precoating agent.

In the present embodiment, when the active ray curable ink applied to the surface of the precoating agent contains a gelling agent, the affinity (close adhesion) between the ink and the precoating agent containing the crystalline resin is more sufficiently enhanced, thereby more sufficiently suppressing ink repulsion and better suppressing tapering and chipping of fine line images.

Examples of the gelling agent include aliphatic ketone waxes, such as dipentadecyl ketone, diheptadecyl ketone, dilignoseryl ketone, dibehenyl ketone, distearyl ketone, dieicosyl ketone, dipalmityl ketone, dimyristyl ketone, lauryl myristyl ketone, lauryl palmityl ketone, myristyl palmityl ketone, myristyl stearyl ketone, myristyl behenyl ketone, palmityl stearyl ketone, palmityl behenyl ketone, and stearyl behenyl ketone; aliphatic ester waxes, such as cetyl palmitate, stearyl stearate, behenyl behenate, icosyl icosanate, behenyl stearate, palmityl stearate, lauryl stearate, stearyl palmitate, myristyl myristate, cetyl myristate, octyldodecyl myristate, steary oleate, stearyl erucate, stearyl linoleate, behenyl oleate, and arachidyl linoleate; amide compounds, such as N-lauroyl-L-glutamic acid dibutylamide and N-(2-ethylhexanoyl)-L-glutamic acid dibutylamide; dibenzylidene sorbitols, such as 1,3:2,4-bis-O-benzylidene-D-glucitol; petroleum waxes, such as paraffin wax, microcrystalline wax, and petrolatum; vegetable waxes, such as candelilla wax, carnauba wax, rice wax, wood wax, jojoba oil, jojoba solid wax, and jojoba ester; animal waxes, such as beeswax, lanolin, and whale wax; mineral waxes, such as montan wax and hydrogenated wax; hydrogenated castor oil or hydrogenated castor oil derivatives; modified waxes, such as montan wax derivatives, paraffin wax derivatives, microcrystalline wax derivatives, or polyethylene wax derivatives; higher fatty acids, such as behenic acid, arachidic acid, stearic acid, palmitic acid, myristic acid, lauric acid, oleic acid, and erucic acid; higher alcohols, such as stearyl alcohol and behenyl alcohol; hydroxystearic acids, such as 12-hydroxystearic acid; 12-hydroxystearic acid derivatives; fatty acid amides, such as lauric acid amide, stearic acid amide, behenic acid amide, oleic acid amide, erucic acid amide, ricinoleic acid amide, and 12-hydroxystearic acid amide; N-substituted fatty acid amides, such as N-stearylstearic acid amide and N-oleylpalmitic acid amide; specialty fatty acid amides, such as N,N′-ethylenebisstearylamide, N,N′-ethylenebis-12-hydroxystearylamide, and N,N′-xylylenebisstearylamide; higher amines, such as dodecylamine, tetradecylamine, or octadecylamine; fatty acid ester compounds, such as stearyl stearate, oleyl palmitate, glycerol fatty acid esters, sorbitan fatty acid esters, propylene glycol fatty acid esters, ethylene glycol fatty acid esters, and polyoxyethylene fatty acid esters; sucrose fatty acid esters, such as sucrose stearate and sucrose palmitate; synthetic waxes, such as polyethylene wax and α-olefin maleic anhydride copolymer wax; polymerizable waxes; dimer acid; and dimer diol. Only one type of these waxes may be used alone, or two or more types thereof may be used in combination.

Among these, from the viewpoint of further enhancing the pinning properties of the ink, aliphatic ketone waxes, aliphatic ester waxes, higher fatty acids, higher alcohols, and fatty acid amides are preferred, and aliphatic ketone waxes or aliphatic ester waxes in which the number of carbon atoms in the carbon chains located on both sides sandwiching the keto group or ester group is 9 or more and 25 or less are more preferred.

The content of the above-described gelling agent is preferably 0.5 mass % or more and 10 mass % or less relative to the entire mass of the active ray curable ink, more preferably 1 mass % or more and 10 mass % or less relative to the entire mass of the active ray curable ink, and still more preferably 2 mass % or more and 7 mass % or less relative to the entire mass of the active ray curable ink.

2-3. Other Components

(Polymerization Inhibitor)

The above-described active ray curable ink may contain a polymerization inhibitor. As the polymerization inhibitor, compounds that are the same as the polymerization inhibitors that can be contained in the above-mentioned precoating agent can be used.

The content of the above-described polymerization inhibitor is not particularly limited, but it can be, for example, 0.05 mass % or more and 0.2 mass % or less relative to the entire mass of the active ray curable ink.

(Colorant)

The above-described active ray curable ink can contain a colorant. The colorant includes pigments and dyes. From the viewpoint of further enhancing the dispersion stability of the active ray curable ink and forming images with high weather resistance, it is preferable that the colorant be a pigment. Examples of the pigment include organic pigments and inorganic pigments. Examples of the dye include a variety of oil-soluble dyes.

The above-described pigment can be used in accordance with the color of images to be formed. For example, it can be selected from a red or magenta pigment, a yellow pigment, a green pigment, a blue or cyan pigment, and a black pigment as described in the color index.

The content of the pigment or dye is not particularly limited, but it is preferably 0.1 mass % or more and 20 mass % or less, and more preferably 0.4 mass % or more and 10 mass % or less, relative to the entire mass of the active ray curable ink. When the content of the pigment or dye is 0.1 mass % or more relative to the entire mass of the active ray curable ink, the color development of the resulting image is sufficient. When the content of the pigment or dye is 20 mass % or less relative to the entire mass of the ink, the viscosity of the ink is not increased too much and moderate flowability of the ink can be obtained.

(Dispersant)

The above-described active ray curable ink may contain a dispersant to disperse the pigment. Examples of the dispersant include hydroxy group-containing carboxylic acid esters, salts of long chain polyaminoamides and high molecular weight acid esters, salts of high molecular weight polycarboxylic acids, salts of long chain polyaminoamides and polar acid esters, high molecular weight unsaturated acid esters, high molecular weight copolymers, modified polyurethanes, modified polyacrylates, polyether ester anionic activators, naphthalenesulfonic acid formalin condensate salts, aromatic sulfonic acid formalin condensate salts, polyoxyethylene alkyl phosphates, polyoxyethylene nonyl phenyl ether, and stearylamine acetate.

The content of the dispersant is preferably 10 mass % or more and 200 mass % or less, and more preferably 20 mass % or more and 100 mass % or less, relative to the entire mass of the pigment. When the content of the dispersant is 10 mass % or more relative to the entire mass of the pigment, the dispersion stability of the pigment is enhanced, and when the content of the dispersant is 200 mass % or less relative to the entire mass of the pigment, the dischargeability of the ink from the inkjet head is stabilized more easily.

(Fixing Resin)

The above-described active ray curable ink may contain a fixing resin in order to further enhance the rubbing resistance and blocking resistance of the coating film.

Examples of the fixing resin include (meth)acrylic resins, epoxy resins, polysiloxane resins, maleic acid resins, vinyl resins, polyamide resins, nitrocellulose, cellulose acetate, ethyl cellulose, ethylene-vinyl acetate copolymers, urethane resins, polyester resins, and alkyd resins.

The content of the fixing resin is not particularly limited, but it can be, for example, 1 mass % or more and 10 mass % or less relative to the entire mass of the active ray polymerizable compound.

(Surfactant)

The above-described active ray curable ink may contain a surfactant.

The surfactant can adjust the surface tension of the ink to adjust the wettability of the ink to the base material after application and to suppress coalescence between adjacent droplets.

Examples of the surfactant include silicone surfactants, acetylene glycol surfactants, and fluorinated surfactants having perfluoroalkenyl groups.

The content of the surfactant is preferably 0.001 mass % or more and 10 mass % or less, and more preferably 0.001 mass % or more and 1 mass % or less, relative to the entire mass of the active ray curable ink.

In addition to the above-described components, the above-described active ray curable ink may contain a viscosity modifier, a resistivity modifier, a film forming agent, an ultraviolet absorber, an antioxidant, a discoloration inhibitor, an antifungal agent, and a rust inhibitor, as necessary.

2-4. Physical Properties of Active Ray Curable Ink

When the above-described active ray curable ink contains a gelling agent, the viscosity of the above-described active ray curable ink at 80° C. is preferably 3 mPa·s or more and 20 mPa·s or less, and more preferably 5 mPa·s or more and 15 mPa·s or less. As a result of this, the injectability when the ink is heated and injected in the inkjet head can be enhanced.

Also, from the viewpoint of allowing the ink to undergo gelation sufficiently when the ink is landed and cooled to ordinary temperature, the viscosity of the above-described active ray curable ink at 25° C. is preferably 1,000 mPa·s or more. This suppresses absorption of the precoating agent by the recording medium, making it easier for the precoating agent to remain on the surface of the recording medium and thus better suppressing ink penetration.

When the above-described active ray curable ink does not contain a gelling agent, the viscosity of the above-described active ray curable ink at 40° C. is preferably 3 mPa·s or more and 20 mPa·s or less, and more preferably 5 m·Pas or more and 15 mPa·s or less. When the above-described viscosity is in the above-described range, the injectability of the ink from the inkjet head can be further enhanced. Also, the viscosity at 25° C. is preferably 1,000 mPa·s or more. When it is 1,000 mPa·s or more, the precoating agent is less likely to be absorbed by the recording medium at the time of landing, and the precoating agent is more likely to remain on the surface of the recording medium.

2-5. Method for Preparing Active Ray Curable Ink

The active ray curable ink can be prepared by mixing the above-mentioned active ray polymerizable compound, polymerization initiator, polymerization inhibitor, and colorant with optional other components under heating. In this case, it is preferable to filter the obtained mixed solution through a predetermined filter. Note that, when preparing the ink containing a pigment, it is preferable to prepare a pigment dispersion containing the pigment and the active ray polymerizable compound, and then to mix the pigment dispersion with other components. The pigment dispersion may further contain a dispersant.

The above-described pigment dispersion can be prepared by dispersing the pigment in the active ray polymerizable compound. The dispersion of the pigment can be carried out using, for example, a ball mill, a sand mill, an attritor, a roll mill, an agitator, a Henschel mixer, a colloid mill, an ultrasound homogenizer, a pearl mill, a wet jet mill, a paint shaker, or the like. At this time, a dispersant may be added.

2-6. Recording Medium

In the present embodiment, the recording medium is not particularly limited as long as the precoating agent can be applied to its surface, and absorbent recording media, as well as non-absorbent and low-absorbent recording media, can be used. In the present invention, remarkable effects can be achieved when absorbent recording media are used.

Examples of the above-described absorbent recording medium include normal paper, wood-free paper, and coated printing sheets such as art paper or coated paper.

Examples of the above-described non-absorbent and low-absorbent recording medium include films. Examples of the above-described film include known plastic films. Examples of the above-described plastic film include polyester (PET) film, polyethylene (PE) film, polypropylene (PP) film, nylon (NY) film, polystyrene (PS) film, ethylene-vinyl acetate copolymer (EVA) film, polyvinyl chloride (PVC) film, polyvinyl alcohol (PVA) film, polyacrylic acid (PAA) film, polycarbonate film, polyacrylonitrile film, and biodegradable films such as polylactic acid film.

3. Image Forming Method

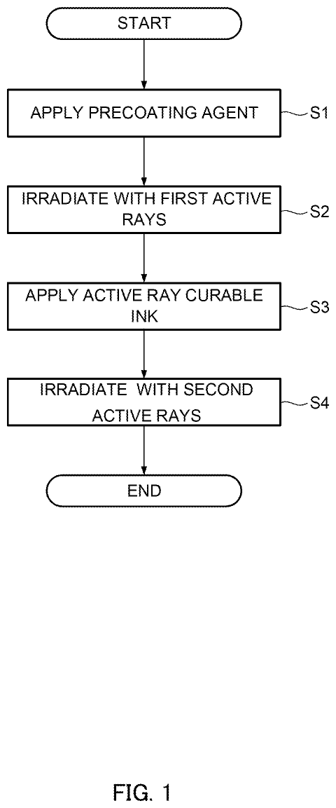

As shown in FIG. 1, an image forming method according to one embodiment of the present invention comprises a step of applying the above-described precoating agent to a surface of a recording medium (step S1); a step of irradiating the above-described surface to which the above-described precoating agent has been applied with first active rays (step S2); a step of applying an active ray curable ink to the above-described surface to which the above-described precoating agent has been applied (step S3); and a step of irradiating the above-described surface to which the above-described active ray curable ink has been applied with second active rays to cure the above-described active ray curable ink (step S4).

3-1. Step of Applying Precoating Agent to Surface of Recording Medium (Step S1)

In the present step, the precoating agent is applied to a surface of a recording medium.

The method for applying the precoating agent is not particularly limited. Examples of the method for applying the precoating agent include known liquid coating methods such as spray coating, spiral coating using a nozzle or slit, dipping coating, roll coater coating, gravure coating, flexographic coating, and inkjet system coating. Among these, from the viewpoint of coatability, it is preferable that the precoating agent be applied to the entire surface of the recording media using the roll coater coating method.

By applying the precoating agent before applying an active ray curable ink to the recording medium, permeation of the ink into the inside of the recording medium can be suppressed and ink penetration can be suppressed.

The amount of the precoating agent applied to the recording medium is preferably 0.1 g/m² or more and 5.0 g/m² or less, and more preferably 0.3 g/m² or more and 3.0 g/m² or less. When the amount of the above-described precoating agent applied is 0.1 g/m² or more, absorption of the precoating agent by the recording medium can be suppressed and the precoating agent can remain sufficiently on the surface of the recording medium, thus better suppressing ink penetration. Also, when the amount of the above-described precoating agent applied is 5.0 g/m² or less, the precoating agent can be cured quickly at the time of irradiation with active rays, and therefore, permeation of the precoating agent into the inside of the recording medium can be suppressed.

3-2. Step of Irradiating with First Active Rays (Step S2)

In the present step, the surface of the recording medium to which the precoating agent has been applied in step S1 is irradiated with first active rays.

The type of the first active rays is not particularly limited. Examples of the first active rays include electron beams, ultraviolet rays, α rays, γ rays, and x rays. Among these, ultraviolet rays or electron beams are preferred as the above-described active rays, and ultraviolet rays are more preferred.

The present inventors have conducted investigations and found that, when using the method in which an active ray curable ink is applied to the surface of the precoating agent and then irradiated with active rays, as described in Japanese Patent Application Laid-Open No. 2020-11381, the active rays sometimes could not sufficiently reach the precoating agent, which is the underlying layer of the ink. Therefore, spreading of ink droplets on the surface of the precoating agent with flowability was suppressed, and tapering of fine line images could not be sufficiently suppressed. Also, due to the above-described reason, even when an image with a large amount of the ink solution was formed, it was sometimes not possible to more fully enhance the color development properties and uniformity of density in the image.

Then, the present inventors have thought of irradiating the precoating agent with active rays before applying an active ray curable ink to enhance the cure degree of the precoating agent. However, when the precoating agent described in Japanese Patent Application Laid-Open No. 2020-11381 was cured, the ink was applied in a state where crystals of the gelling agent were oriented on the surface of the cured film of the precoating agent, which sometimes caused significant ink repulsion. Therefore, tapering and chipping of fine line images could occur, and even in an image with a large amount of the ink solution, the color development properties and in-plane uniformity could be decreased.

In the image forming method according to the present embodiment, by irradiating the above-mentioned precoating agent with the first active rays before applying an active ray curable ink, the active ray polymerizable compound contained in the precoating agent is polymerized. As a result of this, the precoating agent on the recording medium becomes thickened and its flowability is decreased, which thus suppresses the ink from being captured by the precoating agent, and the active ray curable ink applied in step S3, which will be mentioned later, can obtain flowability sufficient for better suppressing tapering of fine line images. Also, by curing the precoating agent containing the above-mentioned crystalline resin, even when an image with a large amount of ink droplets is formed, the color development properties and uniformity of density in the image can be further enhanced while suppressing ink repulsion.

From the above-described viewpoints, in the present step, it is preferable to irradiate the precoating agent with the first active rays to cure it.

Note that, in the present embodiment, a step of applying an active ray curable ink (step S3), which will be mentioned later, may be performed after step S1 without going through the present step.

3-3. Step of Applying Active Ray Curable Ink (Step S3)

In the present step, an active ray curable ink is applied to the surface of the precoating agent to which the first active rays have been applied on the recording medium.

The method for applying the active ray curable ink is not particularly limited. Examples of the method for applying the active ray curable ink include known methods such as spray coating, dipping, screen printing, gravure printing, offset printing, and inkjet method. In the present embodiment, it is preferable to use the inkjet method, in which the active ray curable ink is discharged from an inkjet head and applied to the surface of the above-described precoating agent.

The inkjet head used in the inkjet method may be an inkjet head of either the on-demand system or the continuous system. Examples of the inkjet head for the on-demand system include electro-mechanical conversion systems including single cavity, double cavity, bender, piston, shear mode, and shared wall types, as well as electro-thermal conversion systems including thermal inkjet and bubble jet (“Bubble Jet” is a registered trademark of Canon, Inc.) types.

From the viewpoint of enhancing the dischargeability of droplets of the active ray curable ink, it is preferable to heat the active ray curable ink in the inkjet head to 40 or higher and 120° C. or lower and to discharge the above-described heated active ray curable ink.

In the present step, from the viewpoint of improving the pinning properties of the ink and suppressing tapering and chipping of fine line images, it is preferable for the active ray curable ink to contain a gelling agent.

When the above-described active ray curable ink contains a gelling agent, it is preferable to set the temperature of the active ray curable ink in the inkjet head at a temperature that is 10° C. or more and less than 40° C. higher than the gelation temperature of the active ray curable ink. By setting the temperature of the active ray curable ink in the inkjet head to the gelation temperature +10° C. or higher, the active ray curable ink can be injected well without gelation of the active ray curable ink in the inkjet head or on the surface of the nozzle. Also, by setting the temperature of the active ray curable ink in the inkjet head to lower than the gelation temperature of the active ray curable ink +40° C., the thermal load on the inkjet head can be made smaller. In particular, in inkjet heads using piezoelectric elements, performance degradation due to the thermal load is likely to occur, and therefore, it is particularly preferable to set the temperature of the active ray curable ink to within the above-described range.

At this time, in order to enhance the pinning properties of the active ray curable ink, the surface temperature of the recording medium may be set to near or below the gelation temperature of the gelling agent.

Note that the inkjet head may be an inkjet head of either scan type or line type.

When the active ray curable ink is applied to form a solid image, the amount of ink droplets discharged is preferably 2 pL or more and 30 pL or less, and more preferably 5 pL or more and 20 pL or less. When the amount discharged is 5 pL or more, the color development properties and in-plane uniformity of density in the image can be sufficiently enhanced. When the amount discharged is 20 pL or less, unevenness in image density caused by excessive droplet application can be suppressed.

When the active ray curable ink is applied to form a fine line image, the amount of ink droplets discharged is preferably 1 pL or more and 15 pL or less, and more preferably 3 pL or more and 10 pL or less. When the amount discharged is 2 pL or more, tapering and chipping of fine lines can be better suppressed. When the amount discharged is 10 pL or less, bleeding of fine lines caused by excessive droplet application can be better suppressed.

3-4. Step of Irradiating with Second Active Rays (Step S4)

In the present step, the active ray curable ink, which has been applied to the recording medium in step S3, is irradiated with second active rays to cure the active ray curable ink. As a result of this, while curing the active ray curable ink, the cure degree of the precoating agent can be further enhanced.

The type of the second active rays is not particularly limited. Examples of the second active rays include electron beams, ultraviolet rays, α rays, γ rays, and x rays. Among these, ultraviolet rays or electron beams are preferred as the above-described active rays, and ultraviolet rays are more preferred. Also, the second active rays may be of a different type from the first active rays, or they may be of the same type.

4. Image Forming Apparatus

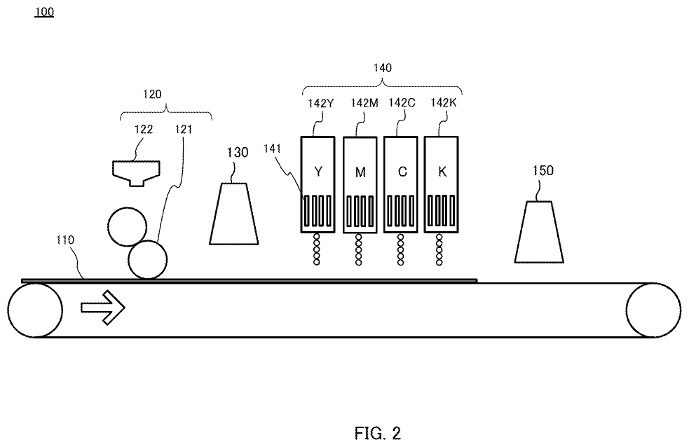

FIG. 2 is a schematic diagram showing an exemplary configuration of inkjet image forming apparatus 100 according to an embodiment of the present invention.

Image forming apparatus 100 according to one embodiment of the present invention comprises: recording medium 110; precoating agent applying section 120 that applies a precoating agent to a surface of recording medium 110; first active ray irradiating section 130 that irradiates the surface of recording medium 110 to which the precoating agent has been applied with first active rays; ink applying section 140 that applies an active ray curable ink to the surface of the recording medium to which the precoating agent has been applied; and second active ray irradiating section 150 that irradiates the surface of recording medium 110 to which the precoating agent and the active ray curable ink have been applied with second active rays.

In FIG. 2, precoating agent applying section 120, first active ray irradiating section 130, ink applying section 140, and second active ray irradiating section 150 are arranged in the order presented from the upstream side along the direction in which the base material is conveyed (the arrow direction in the figure).

Precoating agent applying section 120 may be of any configuration as long as it can apply the precoating agent to a larger area than the area on the recording medium 110 where droplets of the active ray curable ink are landed. For example, precoating agent applying section 120 can be configured to comprise dispenser 122 that supplies the precoating agent to coating roller 121, and coating roller 121 that coats the recording medium with the supplied precoating agent in the form of a film. Note that precoating agent applying section 120 may use the method using a bar coater, the inkjet method, or other methods.

First active ray irradiating section 130 is disposed on the upstream side of ink applying section 140 in the conveyance direction of recording medium 110, and irradiates the surface of recording medium 110 to which the precoating agent has been applied with active rays. As a result of this, an active ray polymerizable compound contained in the precoating agent can be polymerized to thicken the precoating agent, thereby suppressing ink penetration into the precoating agent and providing the ink with flowability sufficient for better suppressing tapering of fine line images.

The type of the first active rays is the same as that of the first active rays in the above-mentioned image forming method, and therefore, a detailed description will be omitted.

Ink applying section 140 is an ink applying section that forms images by the inkjet method in the present embodiment, and has inkjet heads 142Y, 142M, 142C, and 142K for discharging active ray curable compositions (inkjet inks) of the following colors: Y (yellow); 114 (magenta); C (cyan); and K (black), respectively, from nozzles 141 and applying them onto the precoating layer formed on the surface of recording medium 110. Inkjet heads 142Y, 142M, 142C, and 142K apply the above-described active ray curable inks of the respective colors to positions corresponding to an image to be formed on the precoating layer formed on the surface of recording medium 110, thereby forming the image.

Second active ray irradiating section 150 is disposed on the downstream side of ink applying section 140 in the conveyance direction of recording medium 110, and irradiates the surface of recording medium 110 to which the precoating agent and the active ray curable ink have been applied with active rays. As a result of this, second active ray irradiating section 150 irradiates the precoating agent and the active ray curable ink applied to the surface of recording medium 110 with active rays to cure the precoating agent and the active ray curable ink.

The type of the second active rays is the same as that of the second active rays in the above-mentioned image forming method, and therefore, a detailed description will be omitted.

Also, in the above description, images are formed on the surface of the precoating agent applied to the surface of the recording medium by the inkjet method, but the method for forming images is not particularly limited and known methods such as spray coating, dipping, screen printing, gravure printing, and offset printing can be used.

### EXAMPLES

Hereinafter, the present invention will be specifically described with reference to Examples, but the present invention is not limited to them.

1. Synthesis of Crystalline Polyester

(Synthesis of Crystalline Polyester Resin C1)

The raw material monomers described below were placed in a four-neck flask equipped with a nitrogen introduction pipe, a dewatering pipe, a stirrer, and a thermocouple, and were heated to 170° C. and dissolved, thereby obtaining crystalline polyester resin (C1). Obtained crystalline polyester resin (C1) was found to have a weight average molecular weight (Mw) of 22,000, a melting point (Tm) of 76.8° C., and a recrystallization temperature (Rc) of 70.0° C.

| | | |
|---|---|---|
| Dodecanedicarboxylic acid | 103.0 | parts by mass |
| Ethylene glycol | 24.7 | parts by mass |

Note that the respective weight average molecular weights (Mw) in the present Examples are values determined by using a GPC apparatus of “MX-8120” (manufactured by Tosoh Corporation) and columns “TSK guardcolumn+TSKgel SuperHZM-M (three in series)” (manufactured by Tosoh Corporation), and a calibration curve determined from a standard polystyrene sample.

Also, the respective melting points (Tm) in the present Examples are measured values using a differential scanning calorimeter “Diamond DSC” (manufactured by PerkinElmer, Inc.) under temperature rising and cooling conditions where the temperature rising and descending rate is 10° C./min, the temperature rising range is from 25° C. to 150° C., and the temperature descending range is from 150° C. to 0° C.

In addition, the respective recrystallization temperatures (Rc) in the present Examples are measured values using a differential scanning calorimeter “Diamond DSC” (manufactured by PerkinElmer, Inc.) under temperature rising and cooling conditions where the temperature rising and descending rate is 10° C./min, the temperature rising range is from 25° C. to 100° C., and the temperature descending range is from 100° C. to 0° C.

(Synthesis of Crystalline Polyester Resin C2)

The raw material monomers for a crystalline polyester segment described below were placed in a four-neck flask equipped with a nitrogen introduction pipe, a dewatering pipe, a stirrer, and a thermocouple, and were heated to 170° C. and dissolved.

| | | |
|---|---|---|
| Succinic acid | 50.0 | parts by mass |
| 1,12-Dodecanediol | 112.0 | parts by mass |

Next, the raw material compounds for a styrene-acrylic segment described below were added dropwise to the solution obtained as described above with stirring over 90 minutes, and after stirring for 60 minutes, unreacted addition polymerization compounds were removed under reduced pressure (8 kPa). Note that the amount of removed compounds at this time was negligible against the ratio of the above-described raw material compounds for resin.

The raw material compounds for a styrene-acrylic segment described below including a bireactive compound and the radical polymerization initiator described below were placed in a dropping funnel.

| | | |
|---|---|---|
| Styrene (St) | 22.5 | parts by mass |
| 2-Ethylhexyl acrylate (2-EHA) | 7.0 | parts by mass |
| Acrylic acid (AA) | 70.0 | parts by mass |
| Polymerization initiator (di-t-butyl peroxide) | 7.0 | parts by mass |

Thereafter, 0.8 parts by mass of Ti(OBu)₄ was put as an esterification catalyst, the temperature was raised to 235° C., and the reaction was carried out for 5 hours under ordinary pressure (101.3 kPa), and furthermore, for 1 hour under reduced pressure (8 kPa). Next, the resultant mixture was cooled to 200° C., and the reaction was allowed for 1 hour under reduced pressure (20 kPa) to obtain crystalline polyester resin (C2). Obtained crystalline polyester resin (C2) was found to have a weight average molecular weight (Mw) of 15,000, a melting point (Tm) of 71.0° C., a recrystallization temperature (Rc) of 65.8° C., and a styrene-acrylic modification rate of 38.0 mass %.

2. Preparation of Precoating Agent

(Preparation of Precoating Agent P1)

48.0 parts by mass of polyethylene glycol #400 diacrylate, 15.0 parts by mass of tripropylene glycol diacrylate, 15.0 parts by mass of 3PO-modified trimethylolpropane triacrylate, 10.0 parts by mass of 2-phenoxyethyl acrylate, 10.0 parts by mass of isobornyl acrylate, 1.0 part by mass of crystalline polyester C1, 5.0 parts by mass of a photopolymerization initiator (Irgacure 819, manufactured by BASF SE (“Irgacure” is a registered trademark of the company)), and a thermal polymerization inhibitor (Irgastab UV10, manufactured by BASF SE (“Irgastab” is a registered trademark of the company)) were placed in a stainless steel beaker and stirred at 100° C. for 1 hour. Thereafter, by filtration through a Teflon (R) 3 μm membrane filter manufactured by ADVANTEC, precoating agent P1 was obtained.

(Preparation of Precoating Agents P2 to P10)

Precoating agents P2 to P10 were obtained in the same manner as precoating agent P1 except that the formulation of each component was changed to the amounts shown in Table 1.

(Preparation of Precoating Agent P11)

46.0 parts by mass of polyethylene glycol #400 diacrylate, 15.0 parts by mass of tripropylene glycol diacrylate, 15.0 parts by mass of 3PO-modified trimethylolpropane triacrylate, 10.0 parts by mass of 2-phenoxyethyl acrylate, 10.0 parts by mass of isobornyl acrylate, 3.0 part by mass of a gelling agent (behenic acid, Lunac BA, manufactured by Kao Corporation (“Lunac” is a registered trademark of the company)), 5.0 parts by mass of a photopolymerization initiator (Irgacure 819, manufactured by BASF SE (“Irgacure” is a registered trademark of the company)), and a thermal polymerization inhibitor (Irgastab UV10, manufactured by BASF SE (“Irgastab” is a registered trademark of the company)) were placed in a stainless steel beaker and stirred at 100° C. for 1 hour.

Thereafter, by filtration through a Teflon (R) 3 μm membrane filter manufactured by ADVANTEC, precoating agent P11 was obtained.

(Preparation of Precoating Agent P12)

Precoating agent P12 was obtained in the same manner as precoating agent P11 except that polyethylene glycol #400 diacrylate was changed to 49.0 parts by mass and no gelling agent was added.

TABLE 1

| Precoat adjustment level (parts by mass) | | | P1 | P2 | P3 | P4 | P5 | P6 | P7 | P8 | P9 | P10 | P11 | P12 |
|---|---|---|---|---|---|---|---|---|---|---|---|---|---|---|
| Polymerizable | Polyfunctional | Polyethylene | 48.0 | 46.0 | 46.0 | 31.0 | 46.0 | 31.0 | 43.0 | 43.0 | 43.0 | 46.0 | 46.0 | 49.0 |
| monomer | monomer | glycol #400 | | | | | | | | | | | | |
| | oligomer | Tripropylene | 15.0 | 15.0 | 15.0 | 0.0 | 15.0 | 0.0 | 15.0 | 12.0 | 12.0 | 15.0 | 15.0 | 15.0 |
| | | glycol diacrylate | | | | | | | | | | | | |
| | | 3PO-Modified | 15.0 | 15.0 | 0.0 | 0.0 | 15.0 | 0.0 | 12.0 | 12.0 | 12.0 | 0.0 | 15.0 | 15.0 |
| | | trimethylolpropane | | | | | | | | | | | | |
| | | triacrylate | | | | | | | | | | | | |
| | Monofunctional | 2-Phenoxyethyl | 10.0 | 10.0 | 20.0 | 40.0 | 10.0 | 40.0 | 10.0 | 10.0 | 10.0 | 20.0 | 10.0 | 10.0 |
| | monomer | acrylate | | | | | | | | | | | | |
| | | Isobornyl acrylate | 5.0 | 5.0 | 10.0 | 20.0 | 5.0 | 20.0 | 5.0 | 5.0 | 5.0 | 10.0 | 5.0 | 5.0 |

| Gelling agent | | 0.0 | 0.0 | 0.0 | 0.0 | 0.0 | 0.0 | 0.0 | 0.0 | 0.0 | 0.0 | 3.0 | 0.0 |
|---|---|---|---|---|---|---|---|---|---|---|---|---|---|
| Crystalline resin | C1 | 1.0 | 3.0 | 3.0 | 3.0 | 0.0 | 0.0 | 9.0 | 12.0 | 0.0 | 0.0 | 0.0 | 0.0 |
| | C2 | 0.0 | 0.0 | 0.0 | 0.0 | 3.0 | 3.0 | 0.0 | 0.0 | 12.0 | 3.0 | 0.0 | 0.0 |

| | | | | | | | | | | | | |
|---|---|---|---|---|---|---|---|---|---|---|---|---|
| Photopolymerization initiator | 5.0 | 5.0 | 5.0 | 5.0 | 5.0 | 5.0 | 5.0 | 5.0 | 5.0 | 5.0 | 5.0 | 5.0 |
| Thermal polymerization inhibitor | 1.0 | 1.0 | 1.0 | 1.0 | 1.0 | 1.0 | 1.0 | 1.0 | 1.0 | 1.0 | 1.0 | 1.0 |
| Total | 100 | 100 | 100 | 100 | 100 | 100 | 100 | 100 | 100 | 100 | 100 | 100 |

3. Preparation of Pigment Dispersion

20.0 parts by mass of a cyan pigment (Lionol Blue FG-7400-G, manufactured by Toyocolor Co., Ltd.), 6.5 parts by mass of a dispersant “BYKJET-9151” (manufactured by BYK, “BYKJET” is a registered trademark of the company), 73.2 parts by mass of an active ray polymerizable compound, 0.3 parts by mass of a polymerization inhibitor (Irgastab UV10, manufactured by BASF SE), and zirconia beads “YTZ Balls” (0.3 mm, manufactured by Nikkato Corporation) were placed in a 100-mL plastic container. After 3 hours of dispersion in a paint shaker, the zirconia beads were removed to obtain a pigment dispersion.

4. Preparation of Active Ray Curable Ink

(Preparation of Active Ray Curable Ink A)

10 parts by mass of the cyan pigment dispersion, 44.9 parts by mass of polyethylene glycol #400 diacrylate, 25.0 parts by mass of 4EO-modified pentaerythritol tetraacrylate, 15.0 parts by mass of 3PO-modified trimethylolpropane triacrylate, 6.0 parts by mass of a polymerization initiator (Irgacure 819, manufactured by BASF SE), and 1.0 part by mass of a polymerization inhibitor (Irgastab UV10, manufactured by BASF SE) were placed in a stainless steel beaker, and they were stirred at 105° C. for 45 minutes. Thereafter, by filtration through a Teflon (R) 3 μm membrane filter manufactured by ADVANTEC, active ray curable ink A was obtained.

(Preparation of Active Ray Curable Ink B)

Active ray curable ink B was prepared in the same manner as active ray curable ink A except that 1.0 part by mass of a gelling agent (behenic acid, Lunac BA, manufactured by Kao Corporation) was added and the amount of polyethylene glycol #400 diacrylate added was changed to 43.9 parts by mass.

5. Image Forming Method

Hereinafter, Experiments 1 to 16 were carried out using an image forming apparatus having the same configuration as the above-mentioned image forming apparatus 100.

(Experiment 1)

Precoating agent P1 was loaded into a single pass inkjet image forming apparatus having an inkjet head equipped with piezoelectric inkjet nozzles, and the temperature of the above-described inkjet head was set to 80° C. Note that the above-described inkjet head is a piezo head with a nozzle diameter of 20 μm and 1024 nozzles (512 nozzles×2 rows, staggered array, nozzle pitch per row of 600 dpi).

After adjustment of the volume of precoating agent P1 discharged to 2.0 g/m² on a PET film, precoating agent P1 was injected onto wood-free paper (CF paper, manufactured by Konica Minolta, Inc.) at a droplet velocity of about 6 m/s to form a 120 mm×120 mm size image, and a solid image of precoating agent P1 was obtained. Note that the formation of the solid image of precoating agent P1 was carried out in an environment of 23° C. and 55% RH.

(Experiments 2 to 9, 13, 15, and 17)

Solid images of precoating agents P2 to P9, P11, and P12 were obtained in the same manner as in Experiment 1 except that the precoating agent used was changed as shown in Table 2.

(Experiment 10)

Precoating agent P1 was loaded into a single pass inkjet image forming apparatus having an inkjet head equipped with a piezoelectric inkjet nozzle, and the temperature of the above-described inkjet head was set to 80° C. Note that the above-described inkjet head is a piezo head with a nozzle diameter of 20 μm and 1024 nozzles (512 nozzles×2 rows, staggered array, nozzle pitch per row of 600 dpi).

After adjustment of the volume of precoating agent P1 discharged to 2.0 g/m² on a PET film, precoating agent P1 was injected onto coated paper at a droplet velocity of about 6 m/s to form a 120 mm×120 mm size image, and a solid image of precoating agent P1 was obtained. Thereafter, the coated paper was conveyed by a coated paper conveying section and irradiated with 350 mL/cm² ultraviolet rays from a LED lamp (manufactured by Phoseon Technology, 395 nm, water cooled LED) disposed on the downstream side than the inkjet head to obtain a solid image of precoating agent P1 (resolution: 600 dpi×600 dpi). Note that the formation of the solid image of precoating agent P1 was carried out in an environment of 23° C. and 55% RH.

(Experiments 11, 12, 14, and 16)

Solid images of precoating agents P2, P10, and P11 were obtained in the same manner as in Experiment 10 except that the precoating agent used was changed as shown in Table 2.

[Evaluation Methods]

(Fine Line Reproducibility)

Using the above-described image forming apparatus, active ray curable ink A was injected at a droplet velocity of about 6 m/s while adjusting the volume of active ray curable ink A discharged so that the volume of one droplet was 3.0 pL. Then, the coated paper was conveyed by a coated paper conveying section where the temperature of the coated paper on which the solid images of the precoating agents obtained in the above-described Experiments 1 to 12 and 15 to 17 had been formed was set to 45° C., and irradiated with 500 mJ,/cm² ultraviolet rays from a LED lamp (manufactured by Phoseon Technology, wavelength of 395 nm, water cooled LED) disposed on the downstream side than the inkjet head to obtain 2-dot fine line ink images (resolution: 600 dpi×600 dpi). Note that the ink image formation was carried out in an environment of 23° C. and 55% RH. Also, in Experiments 13 and 14, the above-described operations were carried out using active ray curable ink B instead of active ray curable ink A.

For the fine line ink images obtained in Experiments 1 to 17, observation was carried out with an optical microscope (magnification of 50 times, manufactured by Keyence Corporation), and the images were evaluated based on the following criteria.

A: No tapering or chipping was observed in fine lines.

B: Tapering was observed in some fine lines.

D: The lines of fine lines were disconnected.

(Color Development Properties and In-Plane Uniformity in Solid Image)

Using the above-described image forming apparatus, active ray curable ink A was injected at a droplet velocity of about 6 m/s while adjusting the volume of active ray curable ink A discharged so that the volume of one droplet was 5.0 pL. Then, the coated paper was conveyed by a coated paper conveying section where the temperature of the coated paper to which the above-described precoated images 1 to 12 and 15 to 17 had been applied was set to 45° C., and irradiated with 500 mJ/cm² ultraviolet rays from a LEI) lamp (manufactured by Phoseon Technology, wavelength of 395 nm, water cooled LED) disposed on the downstream side than the inkjet head to obtain ink solid images of 100 mm×100 mm (resolution: 600 dpi×600 dpi). Note that the ink image formation was carried out in an environment of 23° C. and 55% RH. Also, in Experiments 13 and 14, the above-described operations were carried out using active ray curable ink B instead of active ray curable ink A.

For the obtained ink solid images, the surface image density state was visually observed and evaluated based on the following criteria.

A: There was no unevenness in density on the image surface and sufficient image density was exhibited (good color development properties).

B: Slight unevenness in density was seen on the image surface, but sufficient image density was exhibited.

C: Slight unevenness in density was seen on the image surface and the image density was a bit low, but there was no problem in terms of quality.

D: Unevenness in density was clearly visible on the image surface, and the image density was low.

(Image Cracking and Peeling)

For the above-described ink solid images, the image side was cut out and mountain-folded to 180° with the image side facing outward, and then a 500 g aluminum block was placed on top and allowed to rest for 30 seconds. Thereafter, the mountain-folded section was opened and the state of fold was observed with the above-described optical microscope (magnification of 50 times) and evaluated based on the following criteria.

A: No crazing or cracking was observed in the fold of the image.

B: Subtle crazings were observed in the fold of the image, but no peeling of the image was observed.

C: Large crazings were observed in the fold of the image and some minor image peeling was observed, but there was no problem in terms of quality.

D: The image was completely peeled off along the fold of the image.

The results of each evaluation for Experiments 1 to 17 are shown in Table 2.

TABLE 2

| | | | | Image evaluation | | |
|---|---|---|---|---|---|---|
| | | | | | Color development | |
| | | | | | properties/in-plane | |
| | Precoating | With or without | | Fine line | uniformity in solid | Image |
| No. | agent | precoat curing | Ink type | reproducibility | image | cracking/peeling |
| Experiment 1 | P1 | Not cured | A | B | C | B |
| Experiment 2 | P2 | Not cured | A | B | A | B |
| Experiment 3 | P3 | Not cured | A | B | A | B |
| Experiment 4 | P4 | Not cured | A | B | A | A |
| Experiment 5 | P5 | Not cured | A | A | A | B |
| Experiment 6 | P6 | Not cured | A | A | A | A |
| Experiment 7 | P7 | Not cured | A | B | A | B |
| Experiment 8 | P8 | Not cured | A | B | B | C |
| Experiment 9 | P9 | Not cured | A | A | B | C |
| Experiment 10 | P1 | Cured | A | A | B | B |
| Experiment 11 | P2 | Cured | A | A | A | B |
| Experiment 12 | P10 | Cured | A | A | A | B |
| Experiment 13 | P2 | Not cured | B | A | B | B |
| Experiment 14 | P2 | Cured | B | A | A | B |
| Experiment 15 | P11 | Not cured | A | D | C | C |
| Experiment 16 | P11 | Cured | A | D | D | D |
| Experiment 17 | P12 | Not cured | A | D | D | C |

In Experiments 1 to 14, evaluations of the fine line reproducibility, the color development properties and in-plane uniformity in the solid image, and the image cracking were all good. In terms of fine line reproducibility, as well as color development properties and in-plane uniformity in the solid image, it is thought that the use of precoating agents containing crystalline resins suppressed ink repulsion, thus achieving good results. Also, in terms of image cracking, it is thought that, since the precoating agents contain crystalline resins, the close adhesion between the precoating agents and the inks was enhanced and image peeling from the precoating agents was suppressed.

Moreover, in Experiments 10 to 12 and 14, by curing the precoating agents before applying the inks, the fine line reproducibility was further made good. This is thought to be because the active ray curable inks applied to the surface of the cured precoating agents obtained flowability and their droplets were allowed to spread out, which resulted in better suppression of tapering of fine line images.

On the other hand, in Experiments 15 and 16, evaluations of the fine line reproducibility, the color development properties and in-plane uniformity in the solid image, and the image cracking were decreased. This is thought to be because the precoating agent contained a gelling agent and the gelling agent oriented on the surface decreased the wettability of the ink to the precoating agent, resulting in occurrence of ink repulsion. Furthermore, in Experiment 16, by curing the precoating agent before applying the ink, the above-described evaluations were further decreased. This is thought to be because the ink was applied in a state where crystals of the gelling agent were oriented on the surface of the cured precoating agent, which caused significant ink repulsion.

Also, in Experiment 17, since the precoating agent contained neither gelling agent nor crystalline resin, penetration of the precoating agent into the recording medium could not be fully suppressed, resulting in ink penetration into the recording medium, which is thought to decrease the fine line reproducibility, and the color development properties and in-plane uniformity in the solid image. In addition, it is thought that the image cracking was decreased because the precoating agent penetrated into the recording medium and thus the close adhesion with the ink could not be sufficiently improved.

By using the precoating agent of the present invention, it is possible to suppress ink repulsion, resulting in suppression of tapering and chipping of fine line images. Therefore, the present invention is useful for image forming methods using active ray curable inks, for example.

Although embodiments of the present invention have been described and illustrated in detail, the disclosed embodiments are made for purposes of illustration and example only and not limitation. The scope of the present invention should be interpreted by terms of the appended claims.

What is claimed is:

1. A precoating agent which is used in an image forming method using an active ray curable ink and which is applied to a surface of a recording medium before the active ray curable ink is applied,
the precoating agent comprising a crystalline resin and an active ray polymerizable compound.

2. The precoating agent according to claim 1, wherein the crystalline resin comprises a crystalline polyester resin.

3. The precoating agent according to claim 2, wherein the crystalline polyester resin comprises a styrene-acrylic modified polyester resin.

4. The precoating agent according to claim 1, wherein a content of the crystalline resin is 1 mass % or more and 10 mass % or less relative to an entire mass of the precoating agent.

5. The precoating agent according to claim 1, wherein a content of the active ray polymerizable compound is 80 mass % or more relative to an entire mass of the precoating agent.

6. The precoating agent according to claim 1, wherein the active ray polymerizable compound comprises a (meth)acrylate.

7. The precoating agent according to claim 1, wherein the active ray polymerizable compound comprises a mono functional compound, and a content of the monofunctional compound is 50 mass % or more relative to an entire mass of the precoating agent.

8. An image forming method comprising:
applying the precoating agent according to claim 1 to a surface of a recording medium;
irradiating, with first active rays, the surface to which the precoating agent has been applied;
applying an active ray curable ink to the surface to which the precoating agent has been applied; and
irradiating, with second active rays, the surface to which the active ray curable ink has been applied.

9. The image forming method according to claim 8, wherein the active ray curable ink comprises a gelling agent.

10. An image forming apparatus comprising:
a precoating agent applicator that applies the precoating agent according to claim 1 to a surface of a recording medium;
a first active ray irradiator that irradiates, with first active rays, the surface to which the precoating agent has been applied;
an ink applicator that applies an active ray curable ink to the surface to which the precoating agent has been applied; and
a second active ray irradiator that irradiates, with second active rays, the surface to which the active ray curable ink has been applied.
